(19) United States
(12) Patent Application Publication
(10) Pub. No.: US 2007/0240991 A1
(43) Pub. Date: Oct. 18, 2007

(54) Gelling Electrophoresis Loading Buffer

(76) Inventor: Zuheir Audeh, Brookline, MA (US)

Correspondence Address: GOSZ AND PARTNERS LLP, ONE STATE STREET, BOSTON, MA, 02109, US

(21) Appl. No.: 11/631,400

(22) PCT Filed: Jun. 27, 2005
(86) PCT No.: PCT/US05/22926

§ 371 Date: May 4, 2007

Related U.S. Application Data
(60) Provisional application No. 60/583,652, filed on Jun. 29, 2004.

(51) Int. Cl. G01N 27/00

(52) U.S. Cl. 204/469; 204/456; 204/606

(57) ABSTRACT

A sample for an electrophoresis device is provided which converts from a liquid to a gel upon contact with the running buffer of an electrophoresis device. The sample preparations of this invention permit improved electrophoresis resolution, image sharpness, and efficiencies of cost, time and space. The sample is prepared by combining a macromolecule of interest, a solvent, and a solute, in proportions to form a liquid which is readily converted to a gel. The sample gels can be used in multiple tray or column electrophoresis devices.

### BACKGROUND OF THE INVENTION

Gel electrophoresis is a technique which is widely used to separate, characterize and identify macromolecules such as proteins, DNA, RNA, etc., based on the electrophoretic mobility of the macromolecule, which includes its size and electric charge. In a typical electrophoresis process, electrically charged particles migrate in solution or suspension under the influence of an applied electric field. The charged particle moves toward the electrode of opposite charge. For a given set of solution conditions, the velocity with which a particle moves divided by the magnitude of the electric field is a characteristic number called the electrophoretic mobility. The electrophoretic mobility is directly proportional to the magnitude of the charge on the particle, and is inversely proportional to the size of the particle. This property has been used to determine protein molecular weights; to distinguish among molecules by virtue of their individual net electrical charge; to detect amino acid changes from charged to uncharged residues or vice versa; and to separate different molecular weight species quantitatively as well as qualitatively. In particular, electrophoresis is widely used to separate, characterize and identify large molecules such as proteins and linear molecules such as DNA and RNA, and strands and fragments of such molecules. More complete and detailed information regarding the basic types of electrophoresis, and the applications for which each type of electrophoresis is utilized, may be found in Freifelder, D., Physical Biochemistry, Applications to Biochemistry and Molecular Biology, 2nd edition, W. H. Freeman and Company, New York, 1982, pages 276-322.

The resolving power of electrophoresis devices can be improved by the use of gel supporting media. Gel electrophoresis methods and electrophoresis devices which utilize gels such as starch, polyacrylamide, agarose, and agarose-acrylamide as supporting media are well established. Generally, agarose and polyacrylamide are the main types of gels used for electrophoretic analysis of nucleic acids. Typically, short to intermediate size fragments (below one thousand base pairs) are separated in polyacrylamide, while intermediate to high molecular weight fragments are separated in agarose gels. Often, the polyacrylamide gel is arranged in a vertical format or column, while the agarose gels are arranged on horizontal trays in slabs or beds.

In addition to having different column, capillary or bed formats, the gel material used in the particular electrophoresis device may present different effective porosity and characteristic ion mobility. By way of example, the concentration of agarose used in the gel for DNA separations may vary from about 2% for separation of nucleic acid fragment under several thousand nucleotides in length, down to about 0.3% for separation of larger fragments having a size in the range of five thousand to sixty-thousand nucleotides. Similarly for polyacrylamide gels, the concentrations may range between about 3% for one-hundred to two-thousand nucleotide chains, up to about 20% for separating smaller molecules of lengths between about five and about one hundred nucleotides.

Run lengths in vertical or horizontal electrophoresis devices typically range from about ten to about one-hundred centimeters, depending on the fragment size and the degree of resolution required. The voltage gradients used may generally be about one to five volts per centimeter. Typically, a separation may take from one to about twenty hours depending upon resolution requirements and other parameters.

In a typical gel electrophoresis run, liquid samples containing either proteins, DNA, or other mixtures to be analyzed, are applied either at the top of the gel that is already covered with running buffer, as in the case of Lemli or column gel electrophoresis, or in a well or trough formed within the gel matrix, as in the case of submerged agarose gel electrophoresis. In all of these cases, the samples to be analyzed are first mixed with a high density loading solution before the application of the sample onto the gel.

Gel loading solutions are typically made from high-density electrophoresis buffers by the addition of solutes such as glycerol, Ficol, sucrose, etc., to the buffer. The mixing of the sample with the high density loading buffer allows the sample to settle on the surface of the gel, or in the sample well in the case of submerged gels, with a minimum amount of mixing between the sample and the running electrophoreses buffer.

It is important to note that the sharpness or tightness of the sample at the point of application of the sample to the electrophoresis gel determines the sharpness and the degree of resolution of the resulting electrophoresis bands at the end of the run. The volume of the sample/loading buffer mixture after its application onto the gel is usually 2 to 4 times greater than the original as a result of the unavoidable mixing between the sample buffer and the running electrophoresis buffer, as well as the fact that the loading buffer containing the sample does not displace all of the running buffer from the sample well. This reduces the relative concentration and increases the volume of the sample, thereby reducing the sharpness and degree of resolution achievable.

Accordingly, it is an objective of this invention to eliminate the problems which may arise as a result of mixing the sample with the running buffer to enhance the sharpness and degree of resolution of the electrophoresis bands. It is an additional objective of this invention to provide a new buffer for gel electrophoresis operation which, when combined with the sample, will accomplish the foregoing objective. It is a further objective of this invention to permit the use of a multiple tray gel electrophoresis device for the simultaneous analysis of a number of stacked gels in one electrophoresis device.

### SUMMARY OF THE INVENTION

The present invention provides methods and techniques for preparing samples for use in electrophoresis devices, as well as samples prepared according to these methods. The invention also relates to electrophoresis systems comprising electrophoresis devices and samples prepared according to the methods of this invention. Moreover, the invention permits the simultaneous analysis of multiple samples in electrophoresis devices containing stacked trays. The sample preparation techniques of this invention provide improved resolution, efficiency and accuracy, at reduced cost, when used with electrophoresis devices for measuring the charge, size and other characteristics of sample molecules.

In one embodiment, a sample for use in an electrophoresis device comprises a macromolecule of interest, a solvent and a solute. The solvent and solute are carefully selected so that the solution formed by combining these two components remains in a liquid state that can be easily converted into a gel by the addition of water. However, the mixture of solvent and solute should be capable of accommodating the additional water contained in the sample solution without forming a gel. Once the sample, solvent and solute are combined, the resulting mixture remains in liquid form until more water is added, causing the formation of a gel. The addition of more water occurs when the sample, solvent and solute combination, referred to herein as the “sample buffer” or “gelling buffer”, is added to the unsubmerged sample well of the electrophoresis device. Upon contact of the gelling buffer with the water-based electrophoresis gel, the sample buffer is converted from a solution into a gel due to polymerization of the sample buffer as a result of the removal of solvent.

In one aspect, the solvent used in the present invention is preferably an organic solvent, and more preferably an organic sulfoxide, such as dimethyl sulfoxide, methylethyl sulfoxide and diethyl sulfoxide. In another aspect, the solute used in the present invention is a compound that forms a gel when dissolved in water, such as agar, agarose, and polysaccharides. The solvent and solute can be combined by dissolving the solute in the solvent at room temperature in specific concentration ranges, followed by mixing for about 10 to 20 minutes.

The solvent/solute mixture is then combined with the sample solution to form the liquid gelling buffer. The gelling buffer is applied to the sample well of the electrophoresis device in liquid form before submerging the gel, and forms a gel upon contact with the sample well. The sample of this invention may be any biological material which is capable of being analyzed by an electrophoresis device, such as a protein, a peptide, an oligonucleotide, typically nucleic acids such as DNA, RNA and the like.

In a further embodiment, the invention relates to a gel electrophoresis system including an electrophoresis device and a sample. The sample is provided in liquid form, but the sample forms a gel upon contact with the sample slot (running gel) of the electrophoresis device. In one aspect, the gel electrophoresis device is a single tray device capable of performing a single analysis on one sample at a time. In another aspect, the gel electrophoresis device is a multiple tray or column device capable of performing independent analyses of more than one sample.

In a still further embodiment, the invention relates to a method for preparing a sample for use with an electrophoresis device comprising combining the sample with a suitable solvent and solute, forming the sample mixture into a gel, and applying the gel to a sample lane of an electrophoresis device.

These and other and its various embodiments will be understood from the description and examples provided herein, taken together with the claims appended hereto.

### DESCRIPTION OF THE PREFERRED EMBODIMENTS

A sample for use in an electrophoresis device is prepared by combining the sample with a suitable solvent and solute in appropriate proportions to form a sample buffer. The physical state of the sample buffer is changed from a liquid to a gel when the sample buffer is contacted with the sample slot or well of the electrophoresis device. As used herein, the term “sample buffer” designates the combination of the sample solution, solvent and solute, in liquid form. The sample buffer is converted into a gel upon contact with the sample well or slot of the electrophoresis device as a result of the removal of the solvent from the solution.

A “gel”, as that term is used in the present invention with reference to the sample, means a solid in which the disperse phase or solute has combined with the continuous phase or solvent to produce a viscous substance or gel. The solute forms a microscopic polymer which retains solvent in the interstices of the gel.

The gel is formed by combining the solute and solvent in appropriate quantities and ratios. Preferably, the solute is dissolved in the solvent at room temperature with stirring for about 10 to 20 minutes. The ratio of water to solvent used depends on the concentration of solute present in the solution.

The term “electrophoresis device”, as used herein, is intended to include both horizontal and vertical gel electrophoresis devices which are employed to analyze the physical characteristics of one or more macromolecules of interest contained in a sample. The electrophoresis device may comprise a single tray or column device, or a multiple tray or column device. Each of these devices is described in U.S. Pat. No. 6,689,267, the disclosure of which is incorporated by reference herein in its entirety.

The solvent and solute which can be used to form the sample gel of this invention are selected on the basis of a variety of factors, including the particular macromolecule of interest in the sample preparation, and the pH of the final mixture. The macromolecule of interest can be, as an example, an oligonucleotide, a nucleic acid, a protein, a peptide, a carbohydrate, a synthetic or natural chemical entity, etc. The solvent and solute employed should be relatively inert and not reactive with the macromolecule contained in the sample, except in the case of a denaturing buffer, such as SDS (sodium dodecylsulfate). The solution formed by combining the sample, solvent and solute should have an approximately neutral pH and be miscible with water.

The solvent used in the present invention can be any liquid that is miscible with water, is compatible with the sample, and is capable of forming a gel when combined with the sample and solute. Preferred solvents include organic sulfoxides, such as dimethyl sulfoxide, methylethyl sulfoxide, and diethyl sulfoxide.

Solutes which can be used in the invention are substances capable of forming a gel when combined with the solvent, such as agar, agarose, and polysaccharides.

The sample, solvent and solute are combined, in proportions, to form the sample buffer. The relative proportion of the solvent and solute used should be sufficient, when combined with the sample solution, to maintain the mixture in liquid form while bringing the solvent:water ratio in the sample solution close to the critical gelling point of the mixture. The “critical gelling point” or “critical gelling concentration” of the sample solution is the point at which a small perturbation of the water/solvent ratio is effective to convert the liquid solution to a gel. The ratio of water to solvent that is sufficient to convert the solution to a gel depends on the amount of solute dissolved in the mixture. For example, when the solute is 0.5% weight by volume of solution, the critical ratio of water to solvent is 1:1. At higher solute concentrations, the ratio of water to solvent is less than 1, but this is not preferred.

Amounts of water added to the sample mixture to increase the aqueous phase beyond the critical gelling point serve to convert the solution into a gel. The sample mixture is added to the sample well of the electrophoresis device in liquid form prior to submersion of the gel to raise the water concentration in the sample above the gelling concentration to convert the sample mixture into a gel. The sample gel formed as a result rests on the running gel of the electrophoresis device.

The sample gel is added to the electrophoresis column or tray prior to the addition of the electrophoresis running buffer. The addition of the running buffer to the gel does not disturb the sample or result in any mixing because the sample is already in gel form upon application to the sample well. Because the sample/gelling buffer mixture is added to the electrophoresis gel before the addition of the running buffer to the electrophoresis column or tray, there is no mixing between the sample and the running buffer after the sample submerged in the running buffer. Preferably, the volume of the sample gelling buffer mixture is approximately the same as the volume of the sample well.

The method of this invention substantially eliminates problems caused by mixing the sample with the running buffer by replacing the sample liquid with a sample gel. By converting the physical state of the sample from a liquid to a gel, the problem of mixing the running buffer and the sample is substantially eliminated. The method of this invention also facilitates the use of multiple lanes on stacked gel arrays which would other wise be inaccessible for sample application.

This new method of sample preparation has a number of advantages. The sample is sharper and less diluted, resulting in a highly resolved and sharper electrophoresis pattern. Moreover, the sample can be applied to the electrophoresis sample row before being submerged in the running buffer, making it easier to apply the samples to the electrophoresis device using either a robotic applicator or a multi-sample pipetter.

The use of multi-gel electrophoresis systems for the analysis of multi-row samples is also now possible as a result of this invention. Current technology does not permit the use of a multi-gel electrophoresis apparatus for the analysis of more than one row of samples per plate. This is because all of the samples have to be applied to submerged electrophoresis gels. If samples are applied to an unsubmerged electrophoresis gel, and then transferred to an electrophoresis box, the running buffer will wash out the fluid sample wells. For this reason, multi-gel electrophoresis is not commonly used. However, the present invention allows the application of samples to the individual gels of multi-gel electrophoresis devices. This is due to the use of a gelling buffer which causes the sample to gel upon contact with the sample well. If the samples are then submerged in the electrophoresis box, the samples will not be disturbed. This provides economies of cost, space and time.

If the sample gelling solution should have an ionic strength or pH that is different from the pH of the running electrophoresis buffer. This produces a discontinuous electrophoresis effect whereby an ionic and pH gradient within the gel is established, provides in some cases improved electrophoresis resolution and band sharpness. It is believed that if the sample gel is more porous than the running gel, the macromolecules will be impeded upon entering the higher density running gel, thereby effectively concentrating the macromolecules at the junction of the two gels.

### EXAMPLE

Dimethyl sulfoxide (DMSO) is selected as a typical solvent for demonstrating the process of this invention. DMSO is miscible with water, it does not evaporate at room temperature, and it is relatively inexpensive.

Agarose is selected as the solute for this example. Agarose is non-toxic, it is easy to work with, and it is a relatively inexpensive gelling agent. Both solvent (DMSO) and solute (agarose) are stable when stored at room temperature.

Agarose powder (from Fisher or Pel-Freeze) is dissolved at room temperature at a concentration of about 0.5 grams per 100 ml DMSO. Due to the varying water content of the agarose powder, the exact ratio of agarose to DMSO may need to be titrated in order to get optimal results. In this format, the solution is liquid and is fairly stable.

This specific solution of agarose in DMSO remains in a liquid form even if an equal volume of water or buffer-containing sample is added to the solution. However, if the water concentration in this sample-containing mixture exceeds about 50% v/v, it immediately changes from a liquid state to a typical gel state. The addition of the 50% water to 50% DMSO-containing sample to a pre-cast agarose or acrylamide gel results in some adsorption of water from the gel to the water/DMSO containing sample, and immediately results in the formation of a gel in the sample slot. After all the samples have been added to the gel, pouring the running buffer over the gel does not disturb the sample, or result in any mixing of the sample with the running buffer.

While this invention has been particularly shown and described with reference to preferred embodiments thereof, it will be understood by those skilled in the art that various changes in form and details may be made therein without departing from the spirit and scope of the invention as defined by the appended claims.

1. A liquid sample for use in an electrophoresis device, said sample comprising, in combination, one or more macromolecules of interest, a solvent and a solute, such that the sample converts to a gel when contacted with the sample well of an electrophoresis device.

2. The sample of claim 1 wherein the solvent is dimethyl sulfoxide.

3. The sample of claim 1 wherein the solute is selected from the group consisting of agarose, agar, and polysaccharides.

4. The sample of claim 1 which is in liquid form prior to contacting the sample well of the electrophoresis device, but forms a gel upon such contact.

5. The sample of claim 1 wherein the macromolecule of interest is an oligonucleotide.

6. The sample of claim 5 wherein the oligonucleotide is DNA or RNA.

7. The sample of claim 1 wherein the macromolecule of interest is a protein or peptide.

8. The sample of claim 1 wherein the ratio of the solvent to water in the sample is the critical gelling concentration based on the concentration of solute in the sample.

9. A multi-gel electrophoresis system comprising a sample and an electrophoresis device, said device having two or more rows for containing a plurality of samples, each row being capable of performing an independent analysis of a sample, wherein each of said samples comprises, in combination, one or more macromolecules of interest, a solvent and a solute.

10. An electrophoresis system comprising a sample and an electrophoresis gel having a slot for receiving a sample, wherein said sample is a gel comprising, in combination, a macromolecule of interest, a solvent and a solute.

11. The electrophoresis systems of claims 9 or 10 wherein the solvent is an organic sulfoxide selected from the group consisting of dimethyl sulfoxide, methylethyl sulfoxide and diethyl sulfoxide.

12. The electrophoresis systems of claims 9 or 10 wherein the solute is selected from the group consisting of agarose, agar, and polysaccharides.

13. The electrophoresis systems of claims 9 or 10 wherein the macromolecule of interest is a nucleic acid.

14. The electrophoresis systems of claims 9 or 10 wherein the macromolecule of interest is a protein or peptide.

15. A method for conducting an electrophoresis process comprising
combining a sample containing a macromolecule of interest with a solvent and a solute to form a liquid sample mixture,
applying the liquid sample mixture to at least one sample well of an electrophoresis device; and
performing an electrophoresis measurement on the macromolecule.
